(19) United States
(12) Patent Application Publication
(10) Pub. No.: US 2026/0104554 A1
(43) Pub. Date: Apr. 16, 2026

(54) MECHANICAL TRANSFER FERRULE RETENTION MECHANISM

(71) Applicant: COTSWORKS, INC., Highland Heights, OH (US)

(72) Inventors: Nick ROSSI, Cleveland, OH (US); Ken APPLEBAUM, Cleveland Heights, OH (US)

(21) Appl. No.: 19/355,469

(22) Filed: Oct. 10, 2025

Related U.S. Application Data
(60) Provisional application No. 63/705,897, filed on Oct. 10, 2024.

(51) Int. Cl. G02B 6/38

(52) U.S. Cl. CPC G02B 6/3858

(57) ABSTRACT

A ferrule retention assembly includes a housing with a front end. The front end has an opening configured to receive a fiber optic ferrule. A clamp is movable between an open position and an engaged position. When the clamp is in the open position, the ferrule can be inserted into the opening. When the clamp is in the closed position, the clamp engages a rear surface of the ferrule to secure the ferrule in the opening. The clamp may be rotatably and slidably connected to the housing. The clamp may be biased toward the front end of the housing to secure the ferrule in the opening.

### RELATED APPLICATIONS

This application claims the benefit of U.S. Provisional Application No. 63/705,897 filed October 10, 2024.

### BACKGROUND

The fiber optic data/telecommunication and sensing industries utilize low cost, off-the-shelf plastic elements for multi-termination connections in an industry (IEC) standardized form factor called an MT ferrule and a Push-Pull connector called a multi-fiber push-on connector, or MPO connector. MPO connectors can be plugged into passive elements which provide cable to cable connections. Alternatively, MPO connectors can be plugged into active devices, like an optical transceiver, which convert the light pulses in the fiber cable to electrical pulses on a circuit card which then travel on a PCBA to a processor or network switch. Current configurations of MPO connectors do not provide reliable connections between MT ferrules for operation in rugged environments where wider temperature, shock, vibration, and humidity ranges are common. Examples of rugged environments include military and aerospace fiber optic data transmission applications.

MPO connectors utilize MT ferrules within them to house twelve or more fibers in a horizontal array. These connectors have guide pins that align the ferrules to each other and springs to hold them together within the MPO outer connector bodies. The MPO outer body utilizes a push-pull mechanism to install and remove the connector. MPO connectors do not include a locking mechanism. Optical transceivers, like Quad Small Form-Factor Pluggable (or QSFP) transceivers, that are used widely throughout the world in data/telecom applications have receptacles for these MPO connectors and have MT ferrules align within the body of the transceiver directly or with a ferrule-to-ferrule jumper cable which then attaches to an optical engine containing optical transmitters, receivers, and associated circuitry to drive the optical to electrical conversions. The push-pull mechanism of an MPO connector does not reliably secure the ferrule in place. Further, MPO connectors are plastic and can deform over time and with exposure to temperatures and rugged environments while the MT ferrule is a glass filled plastic and does not deform as much as the MPO. As such, if MPO connectors and receptacles are used in rugged environments, shock, vibration, humidity, and temperature variances may cause the MT ferrule within the connectors to disconnect or become misaligned.

Current solutions to provide MT Ferrules in rugged or harsh environments include removing the MPO connector and the push-pull connection entirely. The MT ferrule may be secured within substantial metal and hard plastic connector bodies that utilize industry standard connector housings such as the MIL 38999 or similar connector housings. The MT ferrule can only be removed as a part of the connector body which is substantially larger in size and weight when compared to the MT ferrule. Alternatively, a housing can be created around the MT ferrule that attaches to a separate proprietary receptable with screws. Yet another solution includes a sheet metal clip which provides horizontal retaining force from one MT ferrule to another MT ferrule. These clips have not reliably worked and are often reinforced with additional hardware or epoxy. The existing solutions have failed to provide a reliable, robust, cost effective, and compact means for connection MT ferrules in a rugged environment.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, a ferrule retention assembly may include a housing with a front end. The front end can have an opening configured to receive a fiber optic ferrule. A clamp may be movable between an open position and an engaged position. When the clamp is in the open position, the ferrule can be inserted into the opening. When the clamp is in the closed position, the clamp may engage a rear surface of the ferrule to secure the ferrule in the opening. The clamp may be rotatably and slidably connected to the housing. The clamp may be biased toward the front end of the housing to secure the ferrule in the opening.

In another implementation, a ferrule retention assembly may include a housing with a front end, the front end having an opening configured to receive a fiber optic ferrule. A clamp may be rotatably and slidably connected to the housing. The clamp being movable between an open position and an engaged position. A ferrule can be inserted into the opening when the clamp is in the open position. An engagement plate of the clamp engages a back surface of the ferrule and secures the ferrule in the housing when the clamp is in the engaged position. The clamp may be secured in the engaged position with a fastener.

In another implementation, a method for securing a fiber optic ferrule within a ferrule retention assembly may include pulling a clamp away from a housing. The clamp may be rotatably and slidably connected to the housing and biased toward the housing by a biasing member. The biasing member may be captured within the housing. The method may include rotating the clamp to an aligned position where an engagement plate of the clamp is aligned with a front of the housing. The method may include releasing the clamp. When the clamp is released, the clamp allows the biasing member to move the clamp to an engaged position where engagement plate moves toward the housing and engages a fiber optic ferrule placed in an opening in the front of the housing.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 shows a front perspective view of an exemplary ferrule retention assembly with the clamp in the engaged position. FIG. 2 shows a front perspective view of the exemplary ferrule retention assembly with the clamp in the engaged position and engaging a ferrule.

FIG. 3 shows a front perspective view of the exemplary ferrule retention assembly with the clamp in the open position and a ferrule in the opening of the housing. FIG. 4 shows a front perspective view of the exemplary ferrule retention assembly with the clamp in the open position and a ferrule disengaged with the opening.

FIG. 5 shows an exploded view of the exemplary ferrule retention assembly.

FIG. 6 shows a top view of an exemplary ferrule retention assembly with the clamp in the engaged position.

FIG. 7 shows a front perspective view of a second exemplary ferrule retention assembly with the clamp in the engaged position. FIG. 8 shows a rear perspective view of the second exemplary ferrule retention assembly with the clamp in the engaged position.

FIG. 9 shows a front perspective view of the second exemplary ferrule retention assembly with the clamp in the open position. FIG. 10 shows a rear perspective view of the second exemplary ferrule retention assembly with the clamp in the open position.

FIG. 11 shows an exploded view of the second exemplary ferrule retention assembly.

FIG. 12 shows a front perspective cross-section view through the top portion of the housing of the second ferrule retention assembly showing the captured biasing member in the biasing hole. FIG. 13 shows a front perspective cross-section view through the first side of the housing of the second ferrule retention assembly showing the captured biasing member in the biasing hole with the clamp shown in broken line.

FIG. 14 shows a top view of the second exemplary ferrule retention assembly with the clamp in the engaged position. FIG. 15 shows a bottom view of the second exemplary ferrule retention assembly with the clamp in the engaged position.

FIG. 16 shows a top view of the second exemplary ferrule retention assembly with the clamp in the engaged position. FIG. 17 shows a bottom view of the second exemplary retention assembly with the clamp in the open position.

FIG. 18 shows a right side view of the second exemplary ferrule retention assembly with the clamp in the engaged position. FIG. 19 shows a right side view of the second exemplary ferrule retention assembly with the clamp in the open position.

FIG. 20 shows a front view of the second exemplary ferrule retention assembly with the clamp in the engaged position. FIG. 21 shows a front view of the second exemplary ferrule retention assembly with the clamp in the open position.

### DETAILED DESCRIPTION

The ferrule retention assembly includes rugged elements that enable the use of MT ferrules and reliable fiber optic transmission in harsh environments. Used with an active device that includes powered opto-electronics, the ferrule retention assembly maintains a stable connection from the MT ferrule into the device that converts the optical signals to electrical ones over a wide operating temperature and operates under wider shock and vibration profiles than found in the data/telecom industry. The disclosed assembly may be applied in a configuration of back-to-back use where two MT ferrules are clamped in a single housing which can be used inside of an electronics box connecting to a cable that has a box level exit connector or outside of the electronics box where the assembly is on a wall, panel, or rack mount. The disclosed assembly provides a means of securing the MT ferrule and locking the ferrule in place with screws, springs, or both to support the ferrule appropriately so that loss of light is within industry standard even under harsh or rugged operating conditions.

The disclosed assembly utilizes the MT ferrule and its associated guide pins but replaces the MPO with a secure attachment via a rotating element that attaches to the body of the transceiver with a hinge. For instance, the rotating element can be a clamp rotatingly coupled to the transceiver body. The clamp may be metal, plastic, or a combination of both. The assembly may use screws to set the clamp in a closed position and may be spring loaded to lift the clamp once the screws are loosened. A spring may also be used to hold the clamp in a closed position in a different configuration. The clamp is shaped in a way to optimally secure the MT ferrule while also being out its way during insertion or removal. The clamp is also shaped in a way to reduce its weight and thus its impact on force outside of the body of the transceiver. The tolerances of the clamp are such that the body of the transceiver and the body of the ferrule from any manufacturer that meets the IEC standard for MT ferrules, can be securely held in place during rugged operation and storage. The disclosed assembly, however, may be arranged for use with other types of ferrules or cable termini. The clamp does not interfere with the typical hardware used in optical networking and sensing devices.

Screws, springs, other securing means, or a combination thereof may hold the clamp in the closed position where the ferrule is installed. These screws, springs, and other securing means may have washers, retaining mechanisms, and configurations for additional fixing means such as epoxy.

The disclosed subject matter is now described with reference to the drawings, wherein like reference numerals are generally used to refer to like elements throughout. In the following description, for purposes of explanation, numerous specific details are set forth in order to provide a thorough understanding of the disclaimed subject matter. It may be evident, however, that aspects of the appended claims may be practiced without these specific details. In other instances, structures and devices are shown in block diagram form in order to facilitate description.

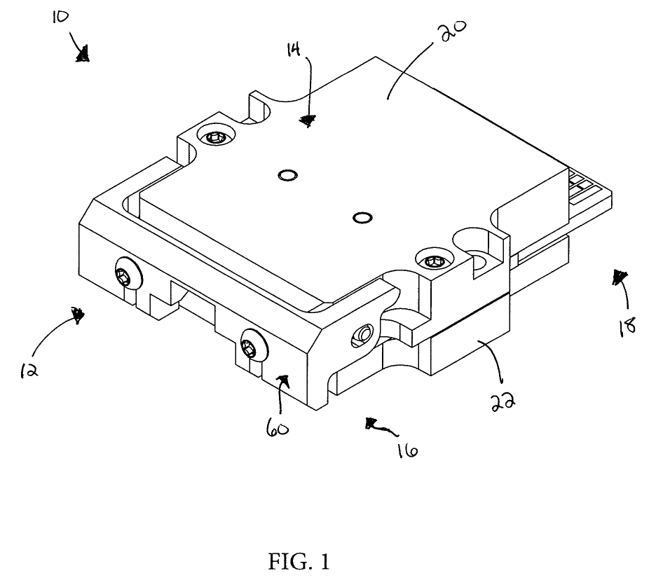

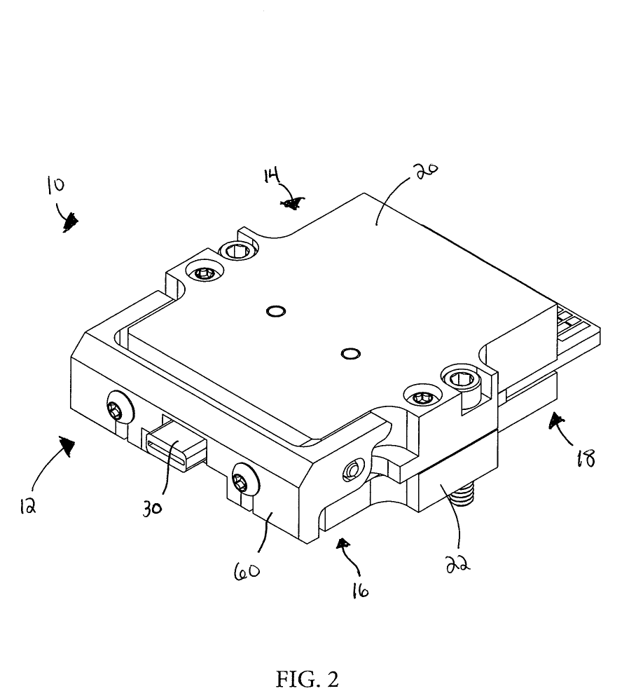

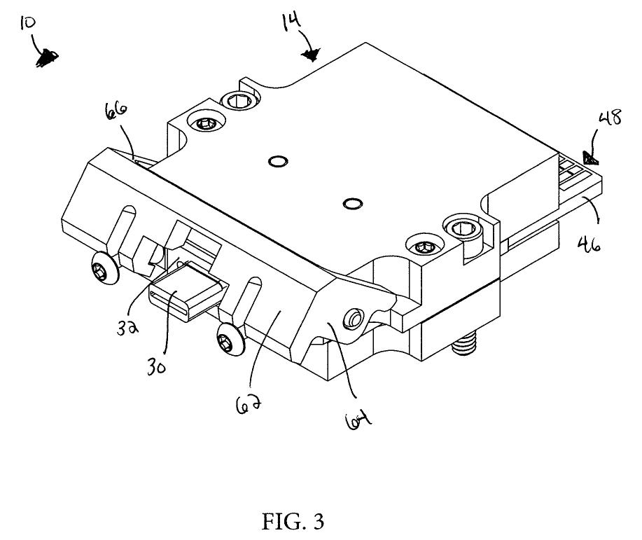

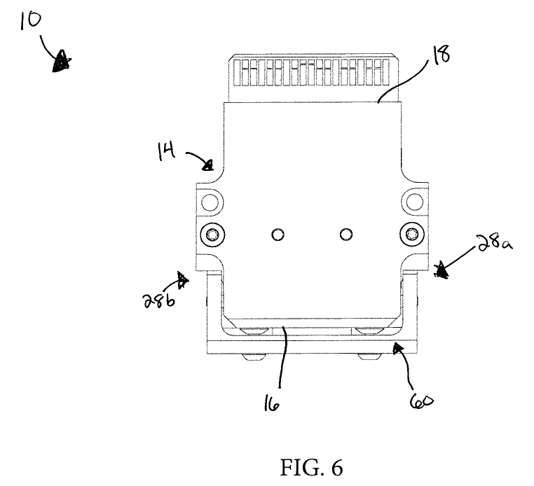

Referring to FIGS. 1-6, the ferrule retention assembly 10 includes a selectively positionable ferrule retention mechanism 12 coupled to a housing 14. The housing 14 has a front side 16 and rear side 18. The ferrule retention mechanism 12 may be positioned on the front side 16 of the ferrule retention assembly. The housing 14 may have a clam shell style configuration such that a top portion 20 of the housing 14 is secured to a bottom portion 22 of the housing 14 to form the housing 14. An internal cavity 24 may be formed between the top portion 20 and the bottom portion 22. The internal cavity 24 may be configured to receive and hold optical and electrical components.

The ferrule retention assembly 10 is configured to receive and secure an MT ferrule 30 that mates with the optical and/or electrical components within the internal cavity 24. While the ferrule retention assembly 10 is described as being used with an MT ferrule 30, it will be appreciated that the ferrule retention assembly 10 can be used to secure other types of data communication ferrules or termini. In one embodiment, the ferrule retention assembly 10 that receives the MT ferrule 30 has a powered active optical element. For instance, the ferrule retention assembly 10 can house an optical transceiver 40 that receives the optical signal from the MT ferrule 30 and converts the optical signals to electrical signals. In this embodiment, the ferrule retention assembly 10 may further house a common optical engine 42 comprising a lens array 44, which may be mounted to a printed circuit board (PCB) 46 together with the transceiver. The front side 16 of the ferrule retention assembly 10 is configured to receive and secure the MT ferrule 30 and the rear side 18 includes an exposed edge 48 of the printed circuit board 46. This exposed edge 48 of the PCB 46 may include electrical landings for connecting and communicating with external electrical devices. For instance, the landings may be configured to conform to industry-standard landing layouts for QSFP transceivers. It will be appreciated that other landing layouts are possible. In some embodiments, the top portion 20 and the bottom portion 22 of the housing 14 may include ledges that extend out from the rear side 18. The ledges may extend out approximately the same distance as the exposed edge 48 of the PCB 46. As such, the ledges may prevent inadvertent contact with the exposed edge 48 of the PCB 46 that could damage the PCB 46.

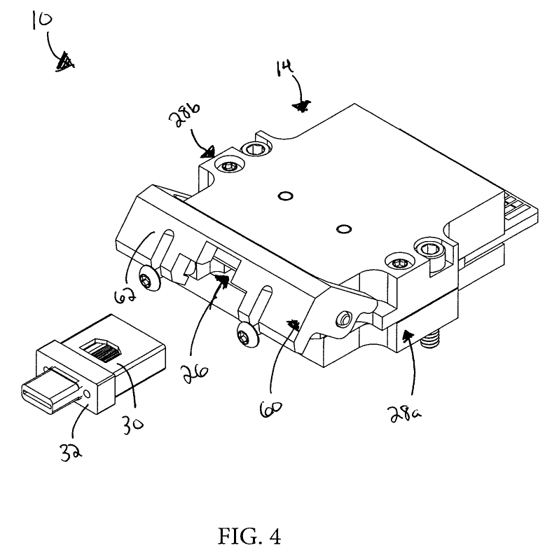

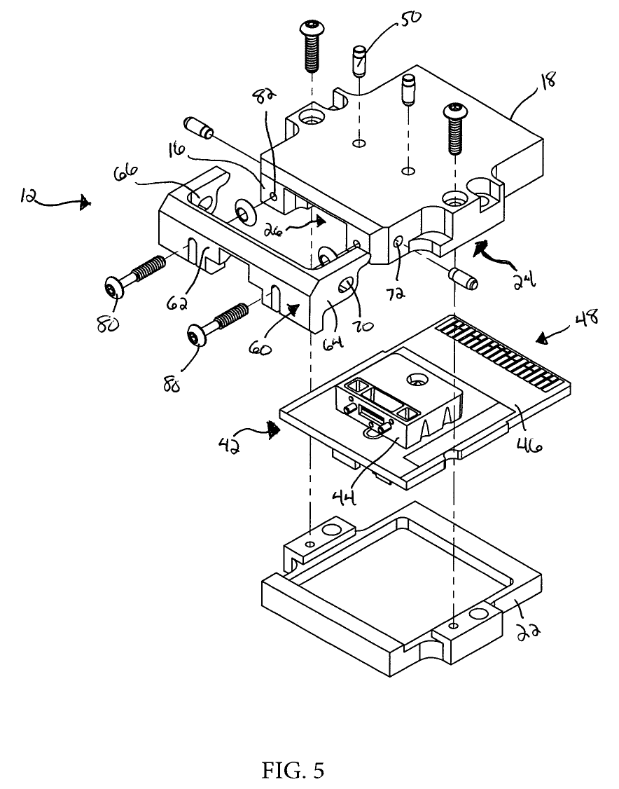

Referring to FIG. 5, the PCB 46 may be set between the top portion 20 and the bottom portion 22 of the housing 14 to eliminate stress on the PCB 46. Further, to further secure the optical engine 42 to the housing 14, the housing 14 may include protrusions 50 that extend downward from the top portion 20 of the housing 14 to engage cutouts or bearing surfaces in the top of the optical engine 42. The protrusions 50 may be inserted into the cutouts and an adhesive or gap-filler may be used to fill in the space between the protrusions 50 and the bearing surfaces. These protrusions 50 may be generally cylindrical. The protrusions 50 may include a cutout to allow more gap-filler to be used between the pin and the bearing surface. In one implementation, the protrusions 50 may be pins extending downward into the internal cavity 24 from the top portion 20 of the housing 14. This method of securing the optical engine 42 may relieve stress on the lens array 44 which is commonly attached to the PCB 46 with an adhesive.

In another implementation, the ferrule retention assembly 10 may be a passive optical element or may be part of a passive optical element, such as a coupler, filter, connector, or adapter. As a passive element, the ferrule retention assembly 10 may be configured to couple a first MT ferrule 30 with a fiber optic ribbon to a second MT ferrule 30 with a fiber optic ribbon. Accordingly, the ferrule retention assembly 10 has a front side 16 configured to receive and secure an MT ferrule 30 and a rear side 18 configured to receive and secure another MT ferrule 30. Once secured in the ferrule retention assembly 10, the first and the second MT ferrules 30 may be mated with each other or with an internal lens configured to transmit light between the MT ferrules 30.

In either an active or passive configuration, a front face of the MT ferrule 30 may be biased into engagement with another device to ensure proper alignment and engagement of the MT ferrule 30 and the optical fibers the MT ferrule 30 houses. In common MPO connectors, the MT ferrule 30 is floating, and this bias is provided by a spring within the connector. This configuration is not reliable in rugged environments where increased vibrations may cause the MT ferrule 30 to become disengaged or misaligned.

The ferrule retention assembly 10 provides a constant bias force to the MT ferrule 30 to secure the ferrule 30 in position and alignment. For securing the ferrule 30, the ferrule retention assembly 10 may include the ferrule retention mechanism 12, which may be a clamp that can move between an open position and an engaged position. In the open position, an MT ferrule 30 or other ferrule 30 can be inserted into an opening 26 in the front side 16 of the ferrule retention assembly. Once the MT ferrule 30 is inserted into the ferrule retention assembly 10 and properly aligned, the ferrule retention mechanism 12 can be moved to the engaged position. In the engaged position, the ferrule retention mechanism 12 provides the bias force to secure the ferrule 30 against and/or in the housing 14 while maintaining the position and alignment of the ferrule 30. The ferrule retention mechanism 12 may be secured or locked in the engaged position for instance with mechanical fasteners. Other means of securing the ferrule retention mechanism 12 in place are discussed in further detail below. While locked in the engaged position, a spring force is applied to the ferrule retention mechanism 12 to minimize the forces transferred to the MT ferrule 30 from the ferrule retention mechanism 12 . This spring force can be provided by spring washers, wave springs, coils springs, rubber dampers, or other suitable hardware engaged with the mechanical fasteners used to secure the ferrule retention mechanism 12 in the engaged position. Once the ferrule 30 is engaged or mated within the ferrule retention assembly 10, for instance where alignment pins on the ferrule 30 are aligned and mated with holes on an optical engine 42 within the housing 14, lateral forces should not be applied to the ferrule 30 to prevent the alignment pins from being damaged. Accordingly, the ferrule retention mechanism 12 may provide the bias force to a rear surface of the ferrule 30 effectively pushing the ferrule 30 into engagement to secure the ferrule 30 in position against the housing 14 and/or optical engine 42.

The ferrule retention mechanism 12 can easily move from the open position to the engaged position. Further, the ferrule retention mechanism 12 can easily move from the engaged position to the open position. As such, the ferrule retention mechanism 12 provides a robust and reliable solution for securing a ferrule 30, like an MT ferrule 30, to an optical device and allows for easy installation and removal of the ferrule 30 from the optical device. In some embodiments, the ferrule retention mechanism 12 may be configured to automatically move from the open position to the engaged position when a ferrule 30 is inserted into the housing 14. A latch may extend through the housing 14. A first end of the latch may be disposed to partially extend into the opening 26 of the housing 14, and a second end of the latch may extend outward from the body and be configured to engage a notch on the ferrule retention mechanism 12. The ferrule retention mechanism 12 may be biased toward the engaged position, but held in the open position when the latch engages the notch on the ferrule retention mechanism 12. When a ferrule 30 is inserted into the opening 26 it may engage the first end of the latch and cause the second end of the latch to disengage with the notch thereby causing the ferrule retention mechanism 12 to move to the close position.

The ferrule retention mechanism 12 may be a captive rotating clamp 60 connected to the body of the housing 14. The clamp 60 may include an engagement plate 62 with a first arm 64 extending out one end of the engagement plate 62 and a second arm 66 extending out another end of the engagement plate 62. The first arm 64 has a proximal end 65a that is joined the engagement plate 62 and a distal end 65b that is configured to connect to or engage a side 28 of the housing 14. The second arm 66 has a proximal end 67a that is joined to the engagement plate 62 and a distal end 67b that is configured to connect to or engage another side of the housing 14. As such, the clamp 60 may be U-shaped. It will be appreciated that when the clamp 60 is engaged with the housing 14, the first arm 64 and the second arm 66 may at least partially extend along the length of the housing 14. In one implementation shown in FIGS. 1-6, to retain the rotating clamp 60 to the housing 14, the rotating clamp 60 may include a slot 70 near the distal end 65b of the first arm 64 of the clamp 60 and a slot 70 near the distal end 67b of the second arm 66 of the clamp 60 that corresponds and aligns with a side hole 72 on either side of the housing 14. The clamp 60 can be rotatably secured onto the housing 14 by inserting a press-fit pin or fastener through the slots 70 on the arms of the clamp 60 and into the side holes 72 in the housing 14 which are configured to receive the pin or fastener. The slots 70 on the arms of the clamp 60 further allow movement of the clamp 60 toward and away from the housing 14. The captive rotating clamp 60 mitigates the risk of foreign object debris (FOD) from interfering with the connection and engagement of the ferrule 30.

In some embodiments, mechanical fasteners 80 are used to secure the clamp 60 in the engaged position. The mechanical fasteners 80 used to secure the clamp 60 in place may be held captive by the rotating clamp 60 and therefore move with the rotating clamp 60. When the clamp 60 is in the closed position the fasteners 80 align with securing holes 82 on the front side 16 of the housing 14 that are configured to receive these fasteners 80. For instance, these securing holes 82 may be threaded. Alternatively, the mechanical fasteners 80 may stay engaged with securing holes 82 while the rotating clamp 60 moves from the open position to the engaged position. The rotating clamp 60 may include securing slots 84 in the engagement plate 62 of the clamp 60 that extend from the bottom 86 of the engagement plate 62 of the clamp 60 up into the engagement plate 62. These securing slots 84 may be configured to receive the shank of the mechanical fastener 80 that extends out from the front of the housing 14. As such, the securing slot 84 may be wide enough to receive the shank of the mechanical fastener but narrow enough to engage the threads of the mechanical fastener or a shoulder included on the fastener. As will be described in further detail below, the slots 84 in the engagement plate 62 also allow for the clamp 60 to be moved from the open position to the engaged position while the mechanical fasteners are installed in the housing 14.

To secure a ferrule 30 using this clamp 60 implementation, an operator can move the clamp 60 to the open position. The operator can insert the ferrule 30 into the housing 14 and properly align and mate the ferrule 30, for instance with the optical engine 42 within the housing 14. To place the clamp 60 in the secured position, the operator can rotate the clamp 60 down over the ferrule 30 and fasten the mechanical fastener 80 to secure the clamp 60 in engaged position. Once fastened, the engagement plate 62 engages the rear surface 32 of the ferrule 30 and the clamp 60 provides a biasing force to the rear surface 32 of the ferrule 30 to bias the ferrule 30 into engagement with components within the ferrule retention assembly 10. It will be appreciated that the operator may need a tool to fasten or loosen the mechanical fastener 80. Alternatively, the mechanical fastener 80 may also include a gripping surface so the operator can fasten or loosen the mechanical fastener 80 by hand. To remove the ferrule 30, the operator can loosen the mechanical fastener 80 and rotate the clamp 60 from the engaged position to the open position. Once the clamp 60 is in the open position, the operator can remove the ferrule 30.

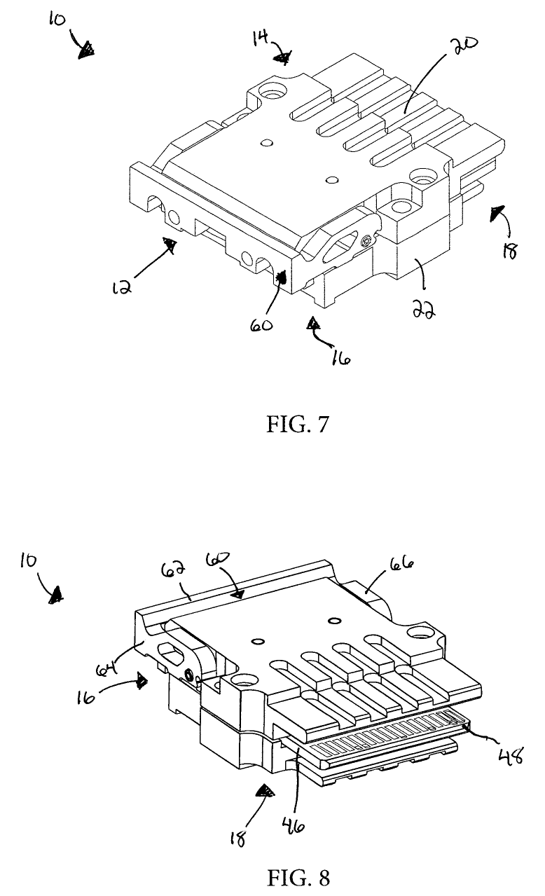

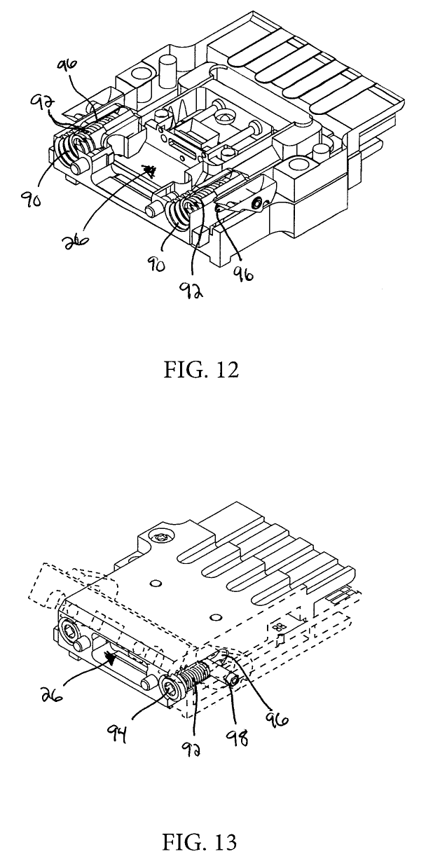

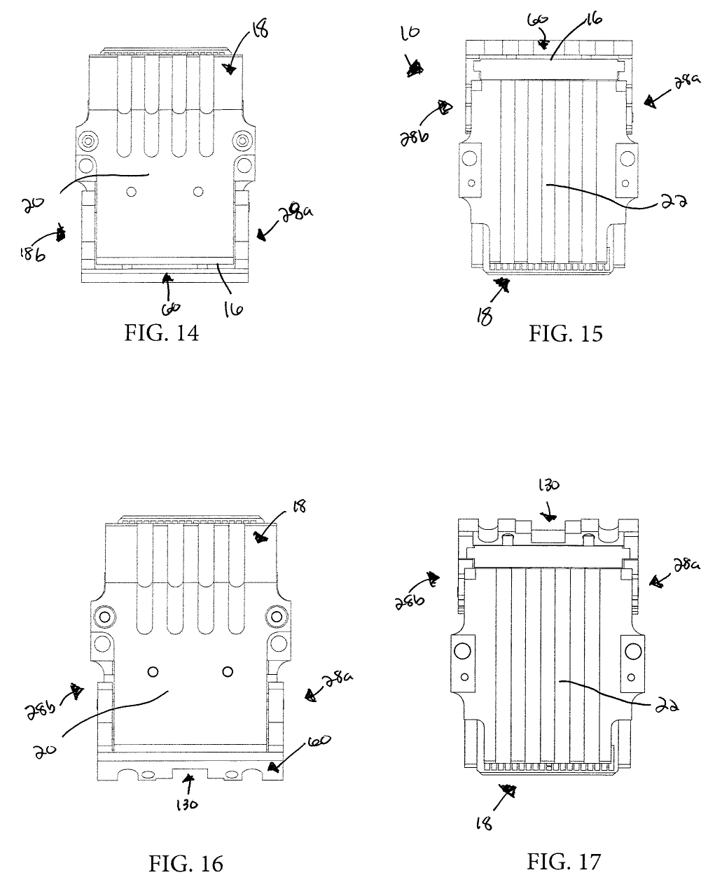

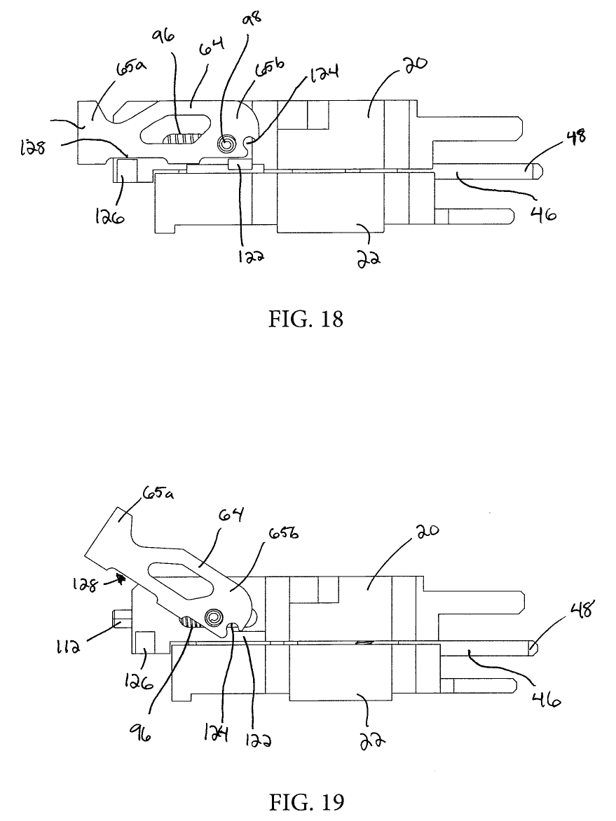

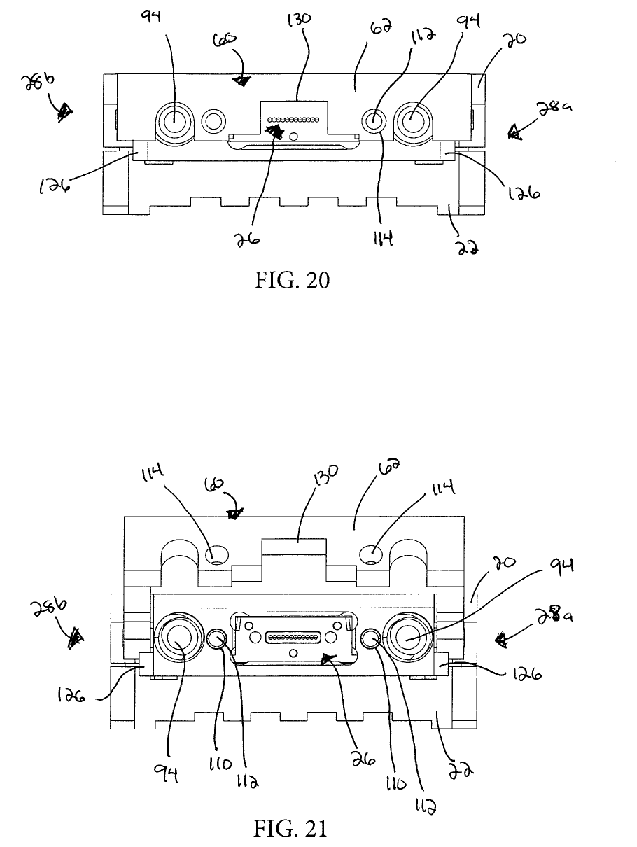

In another implementation shown in FIGS. 7-21, the captive rotating clamp 60 may be spring-loaded. In this configuration, the housing 14 may include at least one biasing hole 90 that extends into the front side 16 of the housing 14 near either a first side 28a or second side 28b of the housing 14. The biasing hole 90 may be configured to receive a biasing member 92, like a spring, as shown in FIGS. 12 and 13. The spring 92 may be retained in the biasing hole 90 using a set screw or a pin 94. A slot 96 extends into each side 28a, 28b of the housing 14 that provides access to the biasing hole 90 from the side 28a, 28b. A first pin 98 is secured to the distal end 65b of the first arm 64 of the clamp 60 and extends inward from the distal end 65b of the first arm 64 of the clamp 60 to engage the slot 96 on the first side 28a of the housing 14. A second pin 100 is secured to the distal end 67b of the second arm 66 of the clamp 60 and extends inward from the distal end 67b of the clamp 60 to engage the slot on the second side 28b of the housing 14. The first pin 98 and the second pin 100 may be press-fit into holes in the respective arms 64, 66 of the clamp 60. Alternatively, the first pin 98 and the second pin 100 may be integrally formed with the respective arms 64,66 of the clamp 60.

When the clamp 60 is installed on the housing 14, the first pin 98 extends into the slot 96 on the first side 28a of the housing 14 and engages the spring 92 within the biasing hole 90 near the first side 28a of the housing 14. Similarly, the second pin 100 extends into the slot 96 on the second side 28b of the housing 14 and engages the spring 92 within the biasing hole 90 near the second side 28b of the housing 14. In this configuration, the spring 92 is disposed between and pushes against the retaining set screw or pin 94 on a first side of the spring and the pin 98, 100 extending into the slot from the clamp 60 on a second side of the spring. As such, this spring-loaded slot and pin configuration biases the clamp 60 toward the housing 14 but allows for the clamp 60 to be pulled away from the housing 14 to move between the open position and the engaged position. The biasing force provided by the spring 92 can be adjusted by rotating the set screw 94. Rotating the set screw 94 to move the set screw 94 further into the biasing hole 90 compresses the spring 92 more and increases the spring force acting on the pins 98, 100 that extend through the slots 96. Conversely, rotating the set screw 94 to move the set screw 94 out of the biasing hole 90 decompresses the spring and decreases the spring force acting on the pins 98, 100 that extend through the slots 96. The engagement plate 62 can include openings that provide access to the set screws 94 to rotate the set screw while the clamp 60 is in the engaged position.

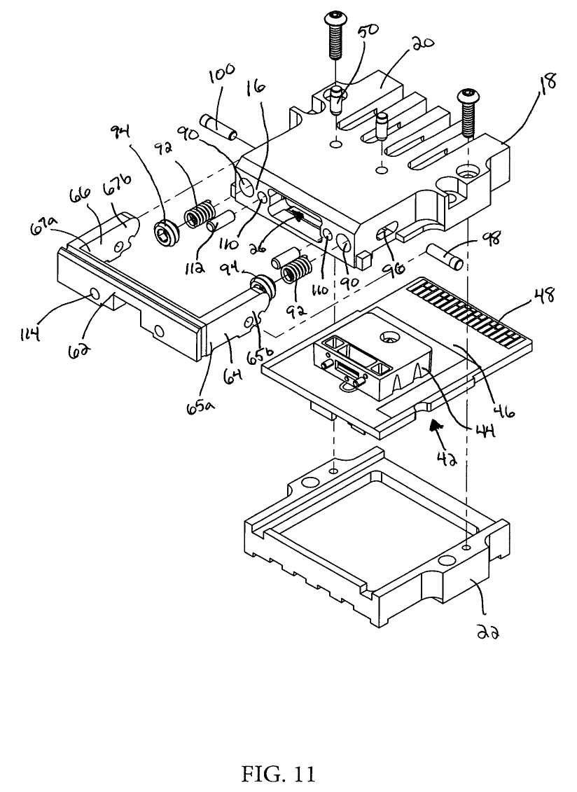

In this implementation, the housing 14 may also include at least one alignment hole 110 that extends into the front side 16 of the housing 14 on either side of the opening 26 that is configured to receive the ferrule 30. As illustrated in FIGS. 11 and 21, the housing 14 has two alignment holes 110, one on each side of the opening 26. The alignment holes 110 are configured to receive an alignment pin 112. The alignment pins 112 can be secured within the alignment holes 110. For instance, the alignment pins 112 may be press-fit within the alignment holes 110. Alternatively, the alignment pins 112 and the alignment pins 110 may be threadably engaged or the alignment pins 112 may be integrally formed with the front side 16 of the housing 14. When the clamp 60 is in the engaged position, the alignment pins 112 are received within corresponding guide holes 114 that extend through the engagement plate 62. As a result, the engagement plate 62 can move toward the front side 16 of the housing 14 to fully engage the ferrule 30 within the opening 26. If the alignment pins 112 and the guide holes 114 are not properly aligned, the alignment pins 112 may engage the engagement plate 62 and prevent the clamp 60 and engagement plate 62 from moving toward the housing 14 to the engaged position, and the ferrule 30 would not be secured in the opening 26.

In an alternative embodiment, the alignment pins 112 may be secured to or integrally formed with the engagement plate 62 so that the alignment pins 112 extend inward from the engagement plate 62. The alignment pins 112 would be received within the alignment holes 110 when the clamp 60 and the housing 14 are properly aligned. Alternatively, the alignment pins can be replaced with mechanical fasteners 80 that are captured on the engagement plate 62 or inserted into the alignment holes 110 through the engagement plate 62. The alignment holes 110 can be threaded and configured to receive the mechanical fastener 80. Therefore, the engagement plate 62 and clamp 60 can be biased toward the housing 14 with the spring and also mechanically fastened to the front side 16 of the housing 14 through the engagement of the mechanical fasteners 80 and the alignment holes 110 to secure the clamp 60 in the engaged position.

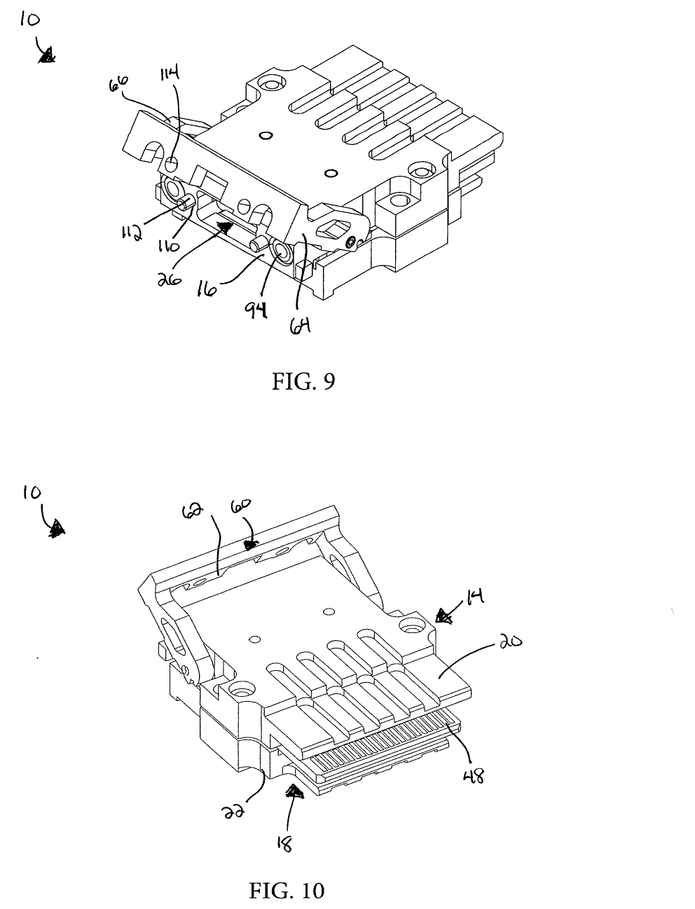

To secure a ferrule 30 using this embodiment, an operator can pull the clamp 60 away from the housing 14 to compress the captured spring 92 and rotate the clamp 60 to the open position shown in FIGS. 9-10. The ferrule 30 can be inserted into the opening 26 of the housing 14 and properly aligned. The operator can then pull the clamp 60 away from the housing 14 to compress the captured spring 92 and rotate the clamp 60 down over the ferrule 30. When the operator releases the clamp 60, the engagement plate 62 of the clamp 60 moves toward the housing 14 and engages the rear surface of the ferrule 30 in the engaged position shown in FIGS. 7-8. In the engaged position, the ferrule 30 is biased towards a secured and mated position relative to optical/electrical components within the housing 14. It will be appreciated that fasteners 80 are not required to secure the clamp 60 in the engaged position, but rather the spring force may be sufficient to secure that clamp 60 in the engaged position. To remove the ferrule 30, an operator can pull the clamp 60 away from the housing 14 when the clamp 60 is in the engaged position to disengage the engagement plate 62 from the ferrule 30 and rotate the clamp 60 to the open position where the ferrule 30 can be easily removed from the optical device.

To limit the rotation of the captive rotating clamp 60, the rotating clamp 60 may have rotation stop 120 extending out of the distal end 65b of the first arm 64 and the distal end 67b of the second arm 66 of the clamp 60. These rotation stops 120 are configured to engage corresponding features of the housing 14 like an integrated ledge or shoulder 122 and provide a physical stop that limits the rotation of the clamp 60. Alternatively, the rotation stops 120 may engage a pin integral with the housing 14 or that is press fit into the housing 14 and extending out of the housing 14. As illustrated, the rotation stop 120 may be a notch at the distal end of the first arm 64 and the second arm 66. When the clamp 60 is in the open position, the notch may engage the ledge or shoulder 122 and hold the clamp in the open position. The permitted range of rotational motion may be selected based on sound engineering principles and judgment based on the needs and application of optical device including the retention mechanism 12. For instance, as previously described slots in the clamp 60 may retain mechanical fasteners 80 that are inserted into holes in the housing 14. The rotational stops can be configured so that the clamp 60 cannot be rotated to a degree where the slots no longer engage the mechanical fasteners. Further, the rotation stops can be designed such that the overall height of the optical device featuring the retention mechanism 12 when the retention mechanism 12 is in the open does not exceed a certain height to conform with industry standards.

To prevent the clamp 60 from rotating past the position where the engagement plate 62 is properly aligned with the front side 16 of the housing 14, the housing 14 may include another rotational stop 126 that is configured to engage a channel 128 in first arm 64 between the proximal end 65a and the distal end 65b and a channel 128 in the second arm 66 between the proximal end 67a and the distal end 67b. The rotation stop 126 may extend outward from the first side 28a and the second side 28b of the housing 14 at or near the front side 16 of the housing 14. When the clamp is rotated downward toward the engaged position, the rotation stop 126 engages the channels 128 and prevents any further rotation. While the rotation stop 126 prevents rotation of the clamp, when the rotation stop 126 is received within the channel 128, the channels 128 are configured to to allow clamp 60 to move toward or away from the housing 14.

In an alternative implementation, the clamp 60 may be separate from the housing 14, or a clip style clamp 60. In this configuration, each side of the housing 14 may have a slot configured to receive a corresponding pin that extends inward from the respective arm of the clamp 60. As an example, each side of the housing 14 may have an L-shaped slot or channel with a width configured to receive a corresponding pin on the clamp 60. Once an MT ferrule 30 is mated with a passive or active optical device, the L-shaped slot allows the clamp 60 to be pushed downward onto housing 14 and then forward to an engaged position that provide the biasing force to the ferrule 30 to ensure the ferrule 30 stays aligned and engaged. To secure the clamp 60 in the engaged position, the engagement plate 62 of the clamp 60 can include holes or slots configured to receive fasteners that align with holes in the housing 14 to receive the fasteners. As previously mentioned above, a spring force can be provided between the engagement plate 62 of the clamp and the housing 14 by spring washers, wave springs, coils springs, rubber dampers, or other suitable hardware on the mechanical fasteners.

The engagement plate 62 of the clamp 60 may include a cutout 130 configured to receive the optical fiber ribbon extending out of the ferrule 30 or a portion of the ferrule 30 receiving the optical fiber ribbon when a ferrule 30 is secured by the ferrule retention mechanism 12 in the engaged position. The engagement plate 62 may also include a foot 132 or a plurality of feet 132 that extend out of the bottom 134 of the engagement plate 62 of the clamp 60 toward the housing 14 and are configured to engaged corresponding features 136, for instance recesses or indents, on the bottom of the housing 14 when the clamp 60 is in the engaged position. The engagement of the feet 132 and the corresponding features 136 on the housing 14 act as an additional physical stop that prevents the clamp 60 from moving to the open position.

The retention mechanism 12 may include an alignment mechanism to ensure proper alignment of the MT ferrule 30 with other MT ferrules 30, optical engines, or other fiber optic elements. The alignment mechanism may provide horizontal alignment to accommodate for MT ferrule manufacturing tolerances. For instance, the alignment mechanism may be a cavity on the engagement plate 62 that extends into the engagement plate 62 and shaped and sized to precisely receive the rear surface of the ferrule.

As previously described, the ferrule retention assembly 10 can be utilized with a passive optical device, like a pass-through connector. In one embodiment, the passive optical device may be a ferrule-to-ferrule adapter or connector like a box wall mount. This connector can include multiple of the ferrule retention assemblies 10. Further, each ferrule retention assembly 10 may be a different configuration of the ferrule retention assembly 10. For example, in one implementation, the optical device may include ferrule retention assembly 10 with mechanical fasteners on both the first side of the optical device and the second side of the optical device. In another implementation, the first side of the optical device may include ferrule retention assembly 10 with mechanical fasteners and the second side of the optical device may include a spring-loaded ferrule retention assembly 10. In yet another implementation, the first and second side of the optical device may both include a spring-loaded ferrule retention assembly 10. The selection of ferrule retention assembly 10 configuration on either side of the optical device can be made according to sound engineering judgment and the application of the optical device.

The ferrule retention assembly 10 can provide a variety of benefits over existing MPO connectors. The MT ferrule retention assembly 10 provides a lightweight and compact connection solution for MT ferrules used in a rugged environment. The MT ferrule is secured within the retention assembly 10 and may mitigate issues present in conventional push-pull mechanisms. The MT ferrule retention assembly 10 is easy to operate. The ferrule retention mechanism 12, or the clamp 60, can easily be moved between the open or closed positions by human hand. Further it is easy to identify the position of the ferrule 30 and the status of the retention, e.g., closed or open. Further, the MT ferrule retention assembly 10 can be made of readily available and cost-effective materials like metals, plastics, or composites. It will be appreciated that MT ferrule retention assembly 10 materials can be selected with sound engineering judgment based on the specific application and the environment in which the mechanism will operate. The ferrule retention assembly can be provided with all captive components and therefore mitigates FOD from interfering with the performance of the optical device featuring the disclosed ferrule retention mechanism 12.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of the claims. It is intended to include all such modifications and alterations in so far as they come within the scope of the appended claims or the equivalents thereof.

What is claimed is:

1. A ferrule retention assembly comprising:
a housing with a front end, the front end having an opening configured to receive a fiber optic ferrule,
a clamp movable between an open position and an engaged position,
wherein the ferrule can be inserted into the opening when the clamp is in the open position, and the clamp is configured to engage a rear surface of the ferrule to secure the ferrule in the opening when the clamp is in the engaged position.

2. The ferrule retention assembly of claim 1, wherein the clamp is rotatably and slidably connected to the housing.

3. The ferrule retention assembly of claim 1, wherein the clamp comprises an engagement plate having a first arm that extends out of a first end of the engagement plate and a second arm that engages out of a second end of the engagement plate such that the clamp is substantially U-shaped, the engagement plate being configured to engage the rear surface of the ferrule.

4. The ferrule retention assembly of claim 3, wherein a first pin extends inward from a distal end of the first arm to slidably and rotatably engage a slot in a first side of the housing and a second pin extends inward from a distal end of the second arm to slidably and rotatably engage another slot in a second side of the housing.

5. The ferrule retention assembly of claim 3, further comprising a biasing member in at least one biasing hole that extends into the front end of the housing, the biasing member being held in the biasing hole by a set screw, the biasing member engaging the set screw at a first end and the first or second pin at the second end, wherein the biasing member is configured to create a biasing force that biases the clamp toward the housing.

6. The ferrule retention assembly of claim 5, wherein the biasing force is adjustable by rotating the set screw into or out of the biasing hole.

7. The ferrule retention assembly of claim 3, wherein the engagement plate has at least one alignment hole that is configured to receive at least one alignment pin extending out of the front end of the housing, wherein the clamp is prevented from moving to the engaged position if the at least one alignment hole is not aligned with the alignment pin.

8. The ferrule retention assembly of claim 3, the housing further comprising a rotation stop that extends outward from a side of the housing and is configured to engage a channel on the first arm or a channel on the second arm when the engagement plate is aligned with the front end of the housing.

9. The ferrule retention assembly of claim 4, the clamp further comprising at least one notch at a distal end of an arm of the clamp configured to engage the housing to prevent rotation of the clamp past the open position and to hold the arm in the open position.

10. The ferrule retention assembly of claim 1, further comprising a card edge of a printed circuit board extending from a rear end of the housing.

11. The ferrule retention assembly of claim 1, the housing further comprising an optical engine disposed within the housing, the optical engine configured to engage the ferrule.

12. A ferrule retention assembly comprising:
a housing with a front end, the front end having an opening configured to receive a fiber optic ferrule,
a clamp that is rotatably and slidably connected to the housing, the clamp being movable between an open position and an engaged position,
wherein the ferrule can be inserted into the opening when the clamp is in the open position, and an engagement plate of the clamp engages a back surface of the ferrule and secures the ferrule in the housing when the clamp is in the engaged position.

13. The ferrule retention assembly of claim 12, further comprising at least one fastener received within the front end of the housing, the at least one fastener being configured to engage the clamp to secure the clamp in the engaged position when the fastener is tightened.

14. The ferrule retention assembly of claim 13, the clamp further comprising at least one slot extending through an engagement plate of the clamp, the at least one slot being positioned to receive the fastener and the at least one slot configured to allow the clamp to be moved from the open position to the engaged position without removing the fastener.

15. The ferrule retention assembly of claim 14, wherein the at least one slot in the engagement plate retains the fastener in the housing when the clamp is in the open position.

16. The ferrule retention assembly of claim 12, further comprising a biasing member between the front end of the housing and the engagement plate of the clamp.

17. The ferrule retention assembly of claim 1, the housing further comprising an optical engine configured to engage the ferrule.

18. A method for securing a fiber optic ferrule within a ferrule retention assembly, the method comprising:
pulling a clamp away from a housing, the clamp being rotatably and slidably connected to the housing and biased toward the housing by a biasing member, the biasing member being captured within the housing;
rotating the clamp to an aligned position where an engagement plate of the clamp is aligned with a front of the housing; and
releasing the clamp,
wherein releasing the clamp allows the biasing member to move the clamp to an engaged position where engagement plate moves toward the housing and engages a fiber optic ferrule placed in an opening in the front of the housing.

19. The method of claim 18, wherein the biasing member is a spring.

20. The method of claim 19, wherein the biasing member is captured in the housing with a set screw threadably coupled to the front end of the housing, the biasing member creating a biasing force that is adjustable by rotating the set screw in to or out of the front of the housing.
